(19) United States
(12) Patent Application Publication
(10) Pub. No.: US 2015/0188487 A1
(43) Pub. Date: Jul. 2, 2015

(54) FAILURE DETECTION DEVICE, FAILURE DETECTION SYSTEM, AND FAILURE DETECTION METHOD

(71) Applicant: JX NIPPON OIL & ENERGY CORPORATION, Tokyo (JP)

(72) Inventors: Masanobu Yoshidomi, Aichi (JP); Takafumi Ishii, Tokyo (JP)

(73) Assignee: JX NIPPON OIL & ENERGY CORPORATION, Tokyo (JP)

(21) Appl. No.: 14/411,745

(22) PCT Filed: Jul. 2, 2013
(86) PCT No.: PCT/JP2013/068171

§ 371 Date: Dec. 29, 2014

(30) Foreign Application Priority Data
Jul. 3, 2012 (JP) 2012-149332

(51) Int. Cl. H02S 50/10

(52) U.S. Cl. CPC H02S 50/10

(57) ABSTRACT

A failure detection device is a failure detection device that detects failure of a bypass diode for at least one photovoltaic string including photovoltaic cells and at least one bypass diode connected in parallel with the photovoltaic cell and disconnected from a load, including a current source circuit that supplies a current having a specified current value from a negative electrode to a positive electrode of the photovoltaic string, a voltage measurement unit that measures a potential difference between the negative electrode and the positive electrode of the photovoltaic string when the current source circuit supplies the current, and a control/determination unit that determines failure of the bypass diode based on the potential difference measured by the voltage measurement unit.

### TECHNICAL FIELD

The present invention relates to a failure detection device, a failure detection system, and a failure detection method for a bypass diode included in a photovoltaic module.

### BACKGROUND ART

Generally, in a photovoltaic module that performs power generation using solar light, a reverse voltage may be applied to a photovoltaic cell, for example, due to an influence of a property variation, a change in solar radiation intensity, or the like. When this reverse voltage is high, there is a risk of heat generation and accordingly damage of the photovoltaic cell. Therefore, a photovoltaic module in which a bypass diode is connected to a photovoltaic cell in parallel to suppress of application of an excessive reverse voltage to the photovoltaic cell is known as a conventional photovoltaic module.

In such a photovoltaic module, a failure detection device that detects open mode (referred also to as opening mode) failure of the bypass diode has been developed, for example, as described in Patent Literature 1 below. In an inspection apparatus described in Patent Literature 1, a photovoltaic cell is shielded by a shielding plate, and a temperature of a shaded part in the photovoltaic cell is detected using a heat sensitive paper integrally formed with the shielding plate. Also, when generation of hotspot heat (abnormal heat generation) in a shielded part of the photovoltaic cell is detected, it is determined that a current does not flow in the bypass diode, and thus it is determined that the bypass diode suffers from opening mode failure.

Further, Patent Literature 2 below discloses a technology for discovering failure of a bypass diode based on electric properties of a photovoltaic module. Specifically, in this diagnosis method, a charged capacitor is connected to a measurement target part other than a blocking diode of the photovoltaic string to be discharged, a voltage and a current of the measurement target part are measured at the time of discharging, and failure of the measurement target part is diagnosed based on a change in a resultant I-V properties.

### CITATION LIST

### Patent Literature

[Patent Literature 1] Japanese Patent Laid-Open Publication No. 2001-024204

[Patent Literature 2] Japanese Patent Laid-Open Publication No. 2011-66320

### SUMMARY OF INVENTION

### Technical Problem

However, in the diagnosis method disclosed in Patent Literature 1, it is necessary to shield the photovoltaic cell so as to detect open mode failure of the bypass diodes. Since solar batteries are usually installed in a high place such as a roof; there are problems in that shielding work is complicated and the method is not suitable for daily test from the viewpoint of safety and cost. Further, when such a technology is applied, it is difficult to determine whether the bypass diode fails for the following reasons. That is, even when the bypass diode does not suffer from open mode failure, a reverse voltage may be applied to the photovoltaic cell to some extent when the photovoltaic cell is shielded, and heat generation of the photovoltaic cell may be observed. A degree of this heat generation depends on solar radiation intensity at that time, a light shielding state, current density of the photovoltaic cell, a heat radiation state of the photovoltaic cell, and a shunt resistor component of the photovoltaic cell. Thus, uniform prediction cannot be performed and it is very difficult to distinguish heat generation in a normal range from heat generation due to failure of the bypass diode. Therefore, the open mode failure of the bypass diode may not be accurately detected.

Further, in the diagnosis method disclosed in Patent Literature 2, when there is no defect in the measurement target part, high current depending on a voltage of a capacitor instantaneously flows to the measurement target part, and thus a current measurement device is likely to fail and the method is not preferable from the viewpoint of safety at the time of measurement. Lowering capacitance of the capacitor is considered to reduce the high current in the measurement target part. However, in this case, since the measurement time of I-V properties is not long, it is difficult to reliably measure the I-V properties, and accuracy of failure diagnosis might decrease.

Therefore, the present invention has been made in view of such problems, and an object of the present invention is to provide a failure detection device, a failure detection system and a failure detection method capable of detecting failure of the bypass diode built in the photovoltaic module reliably and easily while securing safety.

### Solution to Problem

In order to achieve the object, a failure detection device according to an aspect of the present invention is a failure detection device configured to detect failure of a bypass diode for at least one photovoltaic module including a photovoltaic cell that performs power generation using solar light and at least one bypass diode connected in parallel with the photovoltaic cell and disconnected from a load, the failure detection device including: a current source configured to supply a current having a specified current value from a negative electrode to a positive electrode of the photovoltaic module; a voltage measurement unit configured to measure a potential difference between the negative electrode and the positive electrode of the photovoltaic module when the current source supplies the current; and a determination unit configured to determine failure of the bypass diode based on the potential difference measured by the voltage measurement unit.

Further, a failure detection method according to another aspect of the present invention is a failure detection method for detecting failure of a bypass diode for at least one photovoltaic module including a photovoltaic cell that performs power generation using solar light and at least one bypass diode connected in parallel with the photovoltaic cell and disconnected from a load, the failure detection method including: a current supply step of supplying a current having a specified current value from a negative electrode to a positive electrode of the photovoltaic module; a voltage measurement step of measuring a potential difference between the negative electrode and the positive electrode of the photovoltaic module when the current is supplied in the current supply step; and a determination step of determining failure of the bypass diode based on the potential difference measured in the voltage measurement step.

According to such a failure detection device or a failure detection method, the current having a specified current value from the negative electrode to the positive electrode is supplied to the at least one photovoltaic module including at least one bypass diode and disconnected from a load, a potential difference generated between the negative electrode and the positive electrode of the photovoltaic module at that time is measured, and failure of the bypass diode is detected based on the potential difference. That is, if the bypass diode is normal, the potential difference is substantially the same as the voltage drop value of the bypass diode, and if the bypass diode suffers from open mode failure, a voltage drop value of the parasitic resistance of the photovoltaic module (shunt resistor of the photovoltaic cell) is generated, and thus the potential difference becomes greater than the voltage drop value of the bypass diode. Therefore, according to the failure detection device or the failure detection method described above, it is possible to determine the failure of the bypass diode with high accuracy by detecting a difference between the potential differences. Further, measurement of the potential difference in the constant current state reduces a risk of flow of high current in the photovoltaic module, and it is not necessary to scan I-V properties, unlike a failure detection method using a capacitor. Accordingly, it is possible to detect the failure of the bypass diode simply and reliably while securing safety at the time of inspection.

Further, a failure detection system according to still another embodiment of the present invention is a failure detection system configured to detect failure of a bypass diode for a photovoltaic cell system including a photovoltaic string configured by serially connecting a plurality of photovoltaic modules, each including a plurality of photovoltaic cells connected in series and performing power generation using solar light and at least one bypass diode connected in parallel with the plurality of photovoltaic cells, and a load device connected to the photovoltaic string, the system including: a switching unit configured to switch a connection between the photovoltaic string and the load device to a disconnection state; a current source configured to set the photovoltaic string switched to a disconnection state by the switching unit as a detection target string and supply a current having a specified current value from a negative electrode to a positive electrode of the detection target string; a voltage measurement unit configured to measure a potential difference between the negative electrode and the positive electrode of the detection target string when the current source supplies the current; and a determination unit configured to determine failure of the bypass diode based on the potential difference measured by the voltage measurement unit.

Further, a failure detection method according to still another embodiment of the present invention is a failure detection method for detecting failure of a bypass diode for a photovoltaic cell system including a photovoltaic string configured by serially connecting a plurality of photovoltaic modules, each including a plurality of photovoltaic cells connected in series and performing power generation using solar light and at least one bypass diode connected in parallel with the plurality of photovoltaic cells, and a load device connected to the photovoltaic string, the method including: a switching step of switching a connection between the photovoltaic string and the load device to a disconnection state; a current supply step of setting the photovoltaic string switched to a disconnection state in the switching step as a detection target string and supplying a current having a specified current value from a negative electrode to a positive electrode of the detection target string; a voltage measurement step of measuring a potential difference between the negative electrode and the positive electrode of the detection target string when the current is supplied in the current supply step; and a determination step of determining failure of the bypass diode based on the potential difference measured in the voltage measurement step.

According to such a failure detection system or a failure detection method, the current having a specified current value from the negative electrode to the positive electrode is supplied to the photovoltaic string including at least one bypass diode and disconnected from a load, a potential difference generated between the negative electrode and the positive electrode of the photovoltaic string at that time is measured, and failure of the bypass diode is detected based on the potential difference. That is, if the bypass diode is normal, the potential difference is substantially the same as the voltage drop value of the bypass diode, and if the bypass diode suffers from open mode failure, a voltage drop value of parasitic resistance of the photovoltaic string is generated, and thus the potential difference becomes greater than the voltage drop value of the bypass diode. Therefore, according to the failure detection system or the failure detection method described above, it is possible to determine the failure of the bypass diode with high accuracy by detecting a difference between the potential differences. Further, measurement of the potential difference in the constant current state reduces a risk of flow of high current in the photovoltaic string, and it is not necessary to scan I-V properties, unlike a failure detection method using a capacitor. Accordingly, it is possible to detect the failure of the bypass diode simply and reliably while securing safety at the time of inspection.

### Advantageous Effects of Invention

According to the present invention, it is possible to detect the failure of the bypass diode built in the photovoltaic module with high accuracy while securing safety.

### BRIEF DESCRIPTION OF DRAWINGS

FIG. 1 is a configuration diagram illustrating a solar power generation system including a failure detection system according to a first embodiment of the present invention.

FIG. 2 is a diagram illustrating a detailed configuration of a photovoltaic string included in the solar power generation system of FIG. 1.

FIG. 3 is a diagram illustrating an equivalent circuit of a photovoltaic cell 140 of FIG. 2.

FIG. 4 is a graph illustrating current-voltage properties of the photovoltaic string of FIG. 2.

FIG. 5 is a graph illustrating current-voltage properties of the photovoltaic string of FIG. 2.

FIG. 6 is a graph illustrating current-voltage properties of the photovoltaic string of FIG. 2.

FIG. 7 is a configuration diagram illustrating a solar power generation system including a failure detection system according to a modification example of the present invention.

### DESCRIPTION OF EMBODIMENTS

Hereinafter, embodiments of a failure detection device, a failure detection system and a failure detection method according to the present invention will be described in detail with reference to the accompanying drawings. Further, the same elements are denoted with the same reference signs in description of the drawings, and repeated description will be omitted.

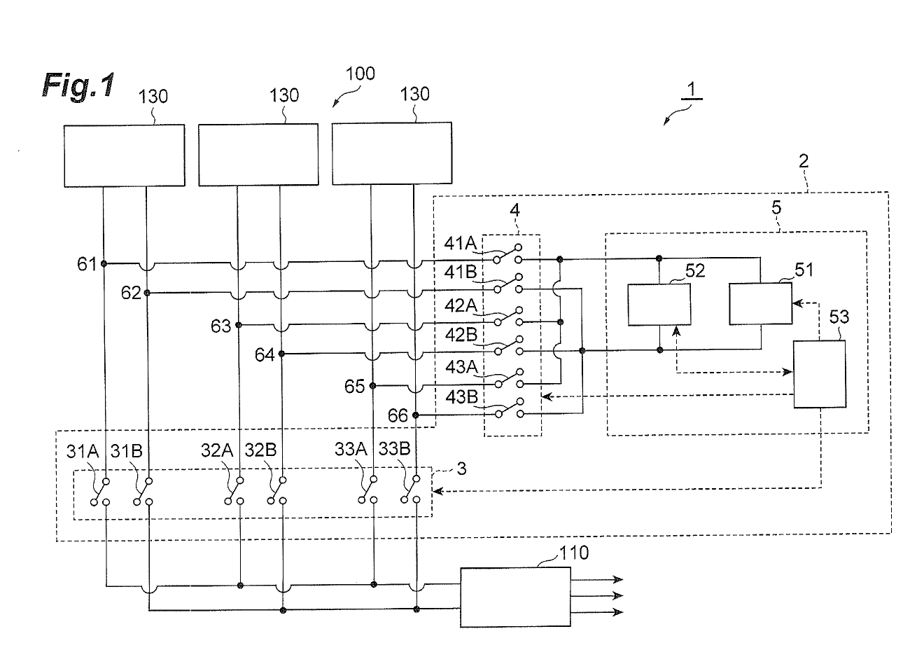

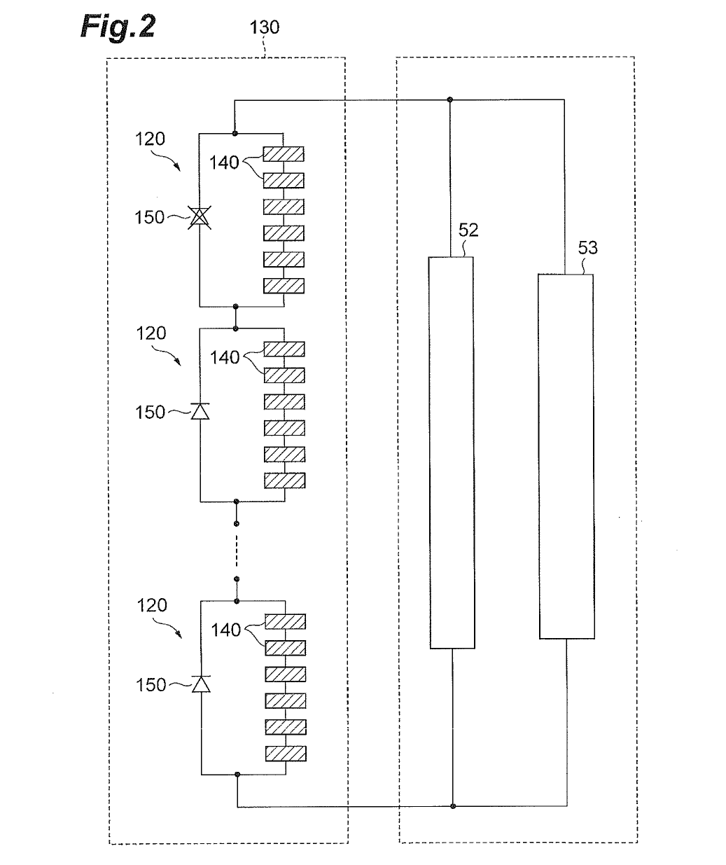

FIG. 1 is a configuration diagram of a solar power generation system according to an embodiment of the present invention, and FIG. 2 is a diagram illustrating a detailed configuration of a photovoltaic string included in the solar power generation system of FIG. 1. The solar power generation system 1 illustrated in FIG. 1 is a power generation system that performs power generation using solar energy. For example, the solar power generation system 1 is a utility connected system installed in a high place such as a roof and having an output voltage of 200 V or more. The solar power generation system 1 includes a photovoltaic array 100, and a power conditioner 110. The solar power generation system is not limited to a utility connected system and may be a stand-alone system that is independent (self-reliant) from a power system.

The photovoltaic array 100 converts solar energy into electric energy and supplies the electric energy to the power conditioner 110 as a direct current output. The photovoltaic array 100 includes at least one photovoltaic string 130 in which a plurality of photovoltaic modules 120 are connected in series, as illustrated in FIG. 2. Here, three photovoltaic strings 130 are connected in parallel with one another to constitute the photovoltaic array 100. These photovoltaic strings 130 are connected to the power conditioner 110 via a switch array of a failure detection system 2 to be described below.

The power conditioner 110 converts the direct current output supplied from the photovoltaic array 100 into an alternating current output and supplies this alternating current output to a power system (for example, a commercial power system) leading to a load device at a subsequent stage. This power conditioner 110 has an operation voltage control function of controlling an operation voltage of the photovoltaic array 100 so that a maximum output of the photovoltaic array 100 is obtained, and a system protection function, such as stopping a system safely when abnormality of the power system is detected. Further, the power conditioner 110 may be a transformer insulation type having an insulation transformer or may be a transformerless (non-insulation) type.

The photovoltaic module 120 is configured in a panel shape, and includes a plurality of (here, six) photovoltaic cells 140 connected to one another in series, as illustrated in FIG. 2. Further, the photovoltaic module 120 includes a bypass diode 150 connected in parallel with the plurality of serially connected photovoltaic cells 140. That is, an anode terminal of the bypass diode 150 is connected to a negative electrode of the photovoltaic module 120, and a cathode terminal of the bypass diode is connected to a positive electrode of the photovoltaic module. Further, the photovoltaic module 120 may include a plurality of photovoltaic cell clusters including a plurality of photovoltaic cells 140 and a bypass diode 150 connected in parallel with the photovoltaic cells 140.

The plurality of photovoltaic cells 140 perform power generation using solar light, and are juxtaposed in a matrix form and fixed to an aluminum frame, and an acceptance surface thereof is covered with reinforced glass. For example, a crystal photovoltaic cell of which the output voltage is 0.5 V is used as the photovoltaic cell 140.

The bypass diode 150 is connected in parallel with a plurality of photovoltaic cells 140. As the bypass diode 150, for example, a Schottky barrier diode is used to reduce a forward voltage and to shorten reverse recovery time. This bypass diode 150 is provided so that a current flows when a reverse voltage is applied to the photovoltaic module 120, and a forward direction thereof is reverse to a forward direction of an equivalent parasitic diode of the photovoltaic cell 140 in the photovoltaic module 120. Specifically, the cathode of the bypass diode 150 is connected to the positive electrode of the photovoltaic module 120 on an electric path that serially connects the photovoltaic modules 120. Further, the anode of the bypass diode 150 is connected to the negative electrode of the photovoltaic module 120 on the electric path.

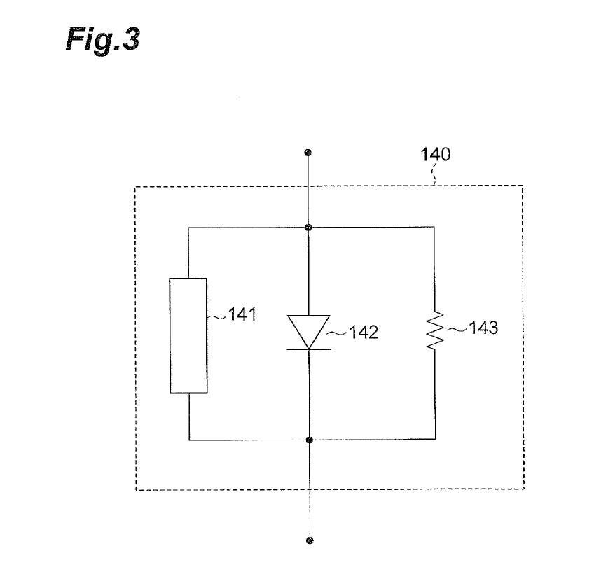

FIG. 3 illustrates an equivalent circuit diagram of the photovoltaic cell 140. The photovoltaic cell 140 can be considered to be equivalent to a parallel circuit of a current source 141, a parasitic diode 142, and a shunt resistor 143, as illustrated in FIG. 3. That is, the photovoltaic cell 140 is equivalent to a cell including the current source 141 that generates a current depending on solar radiation intensity from the negative electrode to the positive electrode inside the cell 140, the parasitic diode 142 of which a forward direction is a direction from the positive electrode to the negative electrode inside the cell 140, and the shunt resistor 143 having a resistance value of hundreds of to 1 kΩ (ideally, infinite Ω). Further, when a current equal to or higher than the current generated by the current source 141 is caused to be generated from the negative electrode to the positive electrode in the photovoltaic cell 140, the current flows to the shunt resistor 143.

Referring back to FIG. 1, a configuration of the failure detection system 2 included in the solar power generation system 1 will be described. The failure detection system 2 is a device group for detecting failure of the bypass diodes 150 included in the photovoltaic string 130 for the photovoltaic string 130 switched to a disconnection state in which the photovoltaic string 130 is disconnected from a load device such as the power conditioner 110. Specifically, the failure detection system 2 includes switch arrays (switching units) 3 and 4, and a failure detection device 5.

The switch array 3 is provided to switch a connection between the three photovoltaic strings 130 and the power conditioner 110 to the disconnection state at the time of inspection of the bypass diodes, and includes six switching elements 31A, 31B, 32A, 32B, 33A, and 33B corresponding to the number of photovoltaic strings 130. The switching elements 31A, 31B, 32A, 32B, 33A, and 33B are switches that control an electrical connection between the photovoltaic strings 130 and the power conditioner 110. Any elements having an arbitrary configuration may be used as the switching elements 31A, 31B, 32A, 32B, 33A, and 33B as long as the elements block a current. For example, semiconductor switches such as FETs (Field Effect Transistors) or IGBTs (Insulated Gate Bipolar Transistors) or electromagnetic switches such as mechanical relays may be used. These switching elements 31A, 31B, 32A, 32B, 33A, and 33B are in a closed state under normal circumstances (at the time of power generation) to connect the photovoltaic strings 130 with the power conditioner 110, whereas are in an opened state at the time of inspection of the bypass diodes to disconnect the photovoltaic strings 130 from the power conditioner 110.

Specifically, the switching elements 31A, 32A, and 33A are provided on an electric path connecting between the positive electrodes of the respective photovoltaic strings 130 and one input terminal of the power conditioner 110, and the switching elements 31B, 32B, and 33B are provided on an electric path connecting between the negative electrodes of the respective photovoltaic strings 130 and the other input terminal of the power conditioner 110. Further, the switch array 3 is provided on both of the electric paths leading to the positive electrode and the negative electrode of the photovoltaic strings 130, but may be provided on any one of the electric paths. For example, the switch array 3 may include only switching elements 31A, 32A, and 33A. Even in such a configuration, each photovoltaic string 130 and the power conditioner 110 can be disconnected from each other at the time of inspection of the bypass diodes.

Further, the switch array 4 is provided to electrically connect the three photovoltaic strings 130 and the failure detection device 5 at the time of inspection of the bypass diodes, and includes six switching elements 41A, 41B, 42A, 42B, 43A, and 43B corresponding to the number of photovoltaic strings 130. The switching elements 41A, 41B, 42A, 42B, 43A, and 43B are switches that control an electrical connection between the photovoltaic strings 130 and the failure detection device 5, and semiconductor switches or electromagnetic switches can be adopted, similarly to the switch array 3. These switching elements 41A, 41B, 42A, 42B, 43A, and 43B are in an opened state under normal circumstances (at the time of power generation) to electrically disconnect the failure detection device 5 from the photovoltaic strings 130, whereas are in a closed state at the time of inspection of the bypass diodes to connect the failure detection device 5 with the photovoltaic strings 13.

Specifically, the switching elements 41A, 42A, and 43A are provided on an electric path connecting between the positive electrodes of the respective photovoltaic string 130 and one connection terminal of the failure detection device 5, and the switching elements 41B, 42B, and 43B are provided on an electric path connecting between the negative electrodes of the respective photovoltaic strings 130 and the other connection terminal of the failure detection device 5. Further, the switch array 4 is provided on both of the electric paths leading to the positive electrode and the negative electrode of the photovoltaic string 130, but may be provided on any one of the electric paths. For example, the switch array 4 may include only the switching elements 41A, 42A, and 43A. Even with such a configuration, the photovoltaic strings 130 and the failure detection device 5 can be caused to be in a disconnection state.

Further, between the photovoltaic string 130 and the power conditioner 110, a backflow prevention diode (not illustrated) that prevents a reverse current from flowing in the photovoltaic string 130 is serially connected on the electric path on the positive electrode side or the negative electrode side (or both sides) of the photovoltaic string 130. This backflow prevention diode may be located in the electric path that is a measurement target of the failure detection device 5 or may be located in a place other than the electric path that is a measurement target. That is, regardless of a position of the switch array 3 or positions of connection points 61 to 66 of the failure detection device 5, the backflow prevention diode may be located in any position on the electric path connecting the positive electrode (or the negative electrode) of the photovoltaic string and the power conditioner 110 (however, it is necessary to be located on the photovoltaic string 130 side relative to a parallel connection point with the other photovoltaic strings 130).

The failure detection device 5 includes a current source circuit 51, a voltage measurement unit 52 and a control/determination unit 53. The current source circuit 51 is a circuit that generates a constant current having a specified current value, and both terminals thereof can be connected to the positive electrodes and the negative electrodes of the three photovoltaic strings 130 via the switching elements 41A, 42A, and 43A and the switching elements 41B, 42B, and 43B. Here, a current value of the current generated by the current source circuit 51 can be adjusted under control of the control/determination unit 53. By such a current source circuit 51, the current having a specified current value directed from the negative electrode to the positive electrode is supplied to any one of the three photovoltaic strings 130.

The voltage measurement unit 52 is a circuit unit for measuring a potential difference between the negative electrode and the positive electrode of the photovoltaic string 130, and both terminals thereof can be connected to the positive electrodes and the negative electrodes of the three photovoltaic strings 130 via the switching elements 41A, 42A, and 43A and the switching elements 41B, 42B, and 43B. Here, a measurement timing of the potential difference by the voltage measurement unit 52 can be controlled by the control/determination unit 53, and a signal indicating the potential difference measured by the voltage measurement unit 52 can be acquired by the control/determination unit 53. The potential difference in any one of the three photovoltaic strings 130 is measured by such a voltage measurement unit 52.

The control/determination unit 53 performs control to switch between the opened and closed states of the switch arrays 3 and 4 and acquires the potential difference measured by the voltage measurement unit 52 at the time of inspection of failure of the bypass diodes. Also, the control/determination unit 53 detects the failure of the bypass diode 150 built in any one of the photovoltaic strings 130 based on the acquired potential difference and outputs a detection result. Such a control/determination unit 53 may be configured of a circuit unit such as an analog circuit or a digital circuit or may be configured of an information processing device such as a microcomputer.

Here, current-voltage properties (hereinafter referred to as “I-V properties”) under normal circumstances and at the time of failure of the bypass diode of the photovoltaic string 130 will be described before details of a function of the control/determination unit 53 are described.

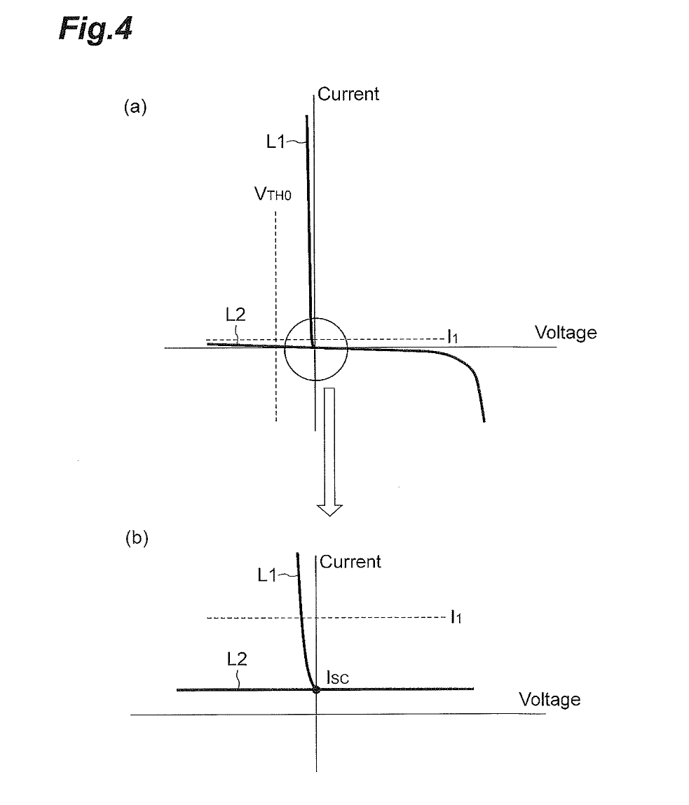

FIG. 4A is a graph illustrating I-V properties at night (at low solar radiation intensity) of the photovoltaic string 130, and FIG. 4B is a graph illustrating a part of the I-V properties of FIG. 4A in detail. In the photovoltaic string 130, when both terminals thereof are short-circuited (V=0), a short-circuit current I_{SC} is generated depending on the intensity of light received by the photovoltaic string, and a value of the current at night is very small, usually 1/1000 of the value in the daytime or less, as illustrated in FIGS. 4A and 4B.

In FIGS. 4A and B, L1 indicates I-V properties of the photovoltaic string 130 under normal circumstances, and L2 indicates I-V properties of the photovoltaic string 130 at the time of failure of the bypass diode. Further, in these properties, a case in which a potential of the positive electrode of the photovoltaic string 130 is higher than a potential of the negative electrode is indicated as a positive voltage (V>0), and a current directed from the negative electrode to the positive electrode inside the photovoltaic string 130 is indicated as a positive current (I>0). Since a plurality of bypass diodes 150 of which the forward direction is a direction directed from the negative electrode to the positive electrode in the inside are included in the photovoltaic string 130, when the positive current (I>0) is generated at night under normal circumstances, a current does not substantially flow to the shunt resistor 143 of the photovoltaic cell 140 (FIG. 3), and most of this current flows forward through the bypass diode 150. As a result, a voltage V of both terminals of the photovoltaic string 130 is a sum (ΣV_{f}) of forward voltages (V_{f}) of the bypass diodes included in the photovoltaic string 130.

On the other hand, when open mode failure (failure in a non-conduction state) occurs in any of bypass diodes 150 included in the photovoltaic string 130 and the positive current (I>0) is generated at night, the current does not substantially flow to the failing bypass diode 150, and flows into the shunt resistor 143 of the photovoltaic cell 140 connected in parallel with the bypass diode 150. Accordingly, the voltage V of both terminals of the photovoltaic string 130 increases substantially linearly as the current increases.

In the present invention, the above-described principle is used, and the voltage when the positive current (I>0) flows at night is measured to determine whether the bypass diode is normal or suffers from open failure. That is, if the bypass diode is normal, a relationship between the voltage (V<0) when the positive current (I>0) flows at night and the sum (ΣV_{f}) of the forward voltages of the bypass diodes is |V|=(ΣV_{f}), whereas if the bypass diode suffers from open mode failure, the relationship is |V|>(ΣV_{f}). This makes it possible to determine whether the bypass diode fails.

Here, even when the sum (ΣV_{f}) of the forward voltages of the bypass diodes is used as a threshold V_{TH0} for a determination, it is possible to determine the failure. However, in this case, there is a risk of false detection as open failure according to a change in V_{f} due to slight fluctuation of a measurement value or a temperature change of the bypass diode though the bypass diode actually functions normally. Therefore, it is preferable for the threshold V_{TH0} for a determination to be a value greater than the sum (ΣV_{f}) of the forward voltages of the bypass diodes. On the other hand, when the bypass diode suffers from open failure, an absolute value of the voltage (V<0) is sufficiently greater than the sum (ΣV_{f}) of the forward voltages of the bypass diodes since the absolute value is a product of the shunt resistance of the photovoltaic cell and the current value, and thus, even when the threshold V_{TH0} for a determination is greater than the sum (ΣV_{f}) of the forward voltages of the bypass diodes, a risk of missing the open failure is less.

Using the I-V properties of the photovoltaic string described above, the control/determination unit 53 determines failure of the bypass diode 150 included in the photovoltaic string 130. Specifically, the control/determination unit 53 controls the switch array 3 to set any one photovoltaic string 130 which is an inspection target (hereinafter referred to as a detection target string) and the power conditioner 110 in a disconnection state, and controls the switch array 4 to connect the detection target string 130 with the current source circuit 51 and the voltage measurement unit 52 of the failure detection device 5. For example, the control/determination unit 53 controls any one of a pair of switching elements 31A and 31B, a pair of switching elements 32A and 32B, and a pair of switching elements 33A and 33B to be in an opened state, and correspondingly controls any one of a pair of switching elements 41A and 41B, a pair of switching elements 42A and 42B and a pair of switching elements 43A and 43B to be in a closed state.

In this state, the control/determination unit 53 controls the current source circuit 51 and generates a current having a current value I₁ greater than an average short-circuit current value I_{SC} for night from the negative electrode to the positive electrode of the detection target string 130. Furthermore, the control/determination unit 53 determines whether the potential difference of the detection target string 130 measured by the voltage measurement unit 52 is greater than the specified threshold V_{TH0} and detects failure of any one of the bypass diodes 150 included in the detection target string 130 when the potential difference is greater than the threshold V_{TH0}. Using the function of such a control/determination unit 53, a determination can be made as to which of properties L1 and L2 illustrated in FIG. 4 are the I-V properties of the detection target string 130, and the failure of the bypass diode 150 can be detected when the I-V properties are determined to be the properties L2. That is, since the potential difference measured by the voltage measurement unit 52 corresponds to a size of the voltage V for the current I=I₁ on the properties L1 and L2, a determination can be made as to which of the properties L1 and L2 is the I-V properties of the detection target string 130 by comparing the potential difference and the threshold V_{TH0}.

Further, if the potential difference of the detection target string 130 measured by the voltage measurement unit 52 when the current having a current value I₁ is supplied to the detection target string 130 is equal to or greater than the threshold V_{TH0} or a previously specified threshold V_{TH1} (>threshold V_{TH0}), the control/determination unit 53 performs control to stop the supply of the current from the current source circuit 51 to the detection target string 130. In this case, the control/determination unit 53 starts monitoring of the potential difference of the detection target string 130 at a timing at which opened and closed states of the switch arrays 3 and 4 are switched for inspection of failure of the bypass diode, and continues to determine whether the supply of the current to the detection target string 130 is to be stopped depending on a monitoring result. It is preferable for the voltage threshold V_{TH1} for stopping the supply of the current to be equal to or smaller than a value obtained by adding an Avalanche breakdown voltage of the photovoltaic cell to the threshold V_{TH0} for determination of failure so that the photovoltaic cells in the photovoltaic string are not damaged due to overvoltage.

Next, a failure inspection procedure for the bypass diode 150 in the solar power generation system 1 described above will be described, and a failure detection method according to this embodiment will be described in detail.

First, the control/determination unit 53 of the failure detection device 5 determines whether a predetermined time arrives using a built-in clock function, and starts a failure inspection process for the bypass diode at a timing at which the arrival of the predetermined time is detected. For example, since the I-V properties in which the short-circuit current value I_{SC} of the photovoltaic string 130 is very small are stable at a timing at which the arrival of night time is detected, false detection of the failure of the bypass diode is prevented by starting the failure inspection process at this timing.

Further, when the detection is performed at night, the detection is possible with a small current value, and thus safe detection is possible.

Then, the switch arrays 3 and 4 are controlled by the control/determination unit 53, any one of the detection target strings 130 and the power conditioner 110 is set in a disconnection state, and the detection target string 130 and the failure detection device 5 are connected (a first switching step). Here, when the disconnection state is set, both electrodes of the detection target string 130 may be cut, and only the one pole of the detection target string 130 may be cut.

Thereafter, a current having a current value I₁ from the negative electrode to the positive electrode is supplied from the current source circuit 51 of the failure detection device 5 to the detection target string 130 (current supply step). At this timing, a potential difference between the negative electrode the positive electrode of the detection target string 130 is measured by the voltage measurement unit 52, and a measurement value is sent to the control/determination unit 53 (voltage measurement step). Accordingly, the control/determination unit 53 determines whether the measurement value of the potential difference is greater than a specified threshold V_{TH0}, and detects failure of any of the bypass diodes 150 included in the detection target string 130 based on the determination result (determination step). Also, the control/determination unit 53 outputs a detection result to an output device such as a display or an LED (output step). Finally, when the failure of the bypass diode is not detected (when it is determined that the bypass diode is normal), the control/determination unit 53 controls the switch arrays 3 and 4 to release the connection between the detection target string 130 and the failure detection device 5 and set the detection target string 130 and the power conditioner 110 to a connection state (second switching step).

According to the failure detection system 2 described above and the failure detection method for the bypass diode using this, the current having the specified current value I₁ from the negative electrode to the positive electrode is supplied to the photovoltaic string 130 disconnected from the load device, the potential difference generated between the negative electrode and the positive electrode of the photovoltaic string 130 at this time is measured, and failure of the bypass diode 150 is detected based on the potential difference. That is, if the bypass diode 150 is normal, the potential difference is substantially the same as the voltage drop value of the bypass diode 150, and if the bypass diode 150 suffers from open mode failure, a voltage drop value of the parasitic resistance (shunt resistor 143) of the photovoltaic cell 140 is generated, and thus the potential difference becomes greater than the voltage drop value of the bypass diode 150. Therefore, according to the failure detection method using the failure detection system 2 described above, it is possible to reliably determine the failure of the bypass diode 150 by detecting a difference between the potential differences. Further, measurement of the potential difference in the constant current state reduces a risk of flow of high current in the photovoltaic string, and it is not necessary to scan the I-V properties, unlike a failure detection method using a capacitor in the related art. Accordingly, it is possible to detect the failure of the bypass diode 150 simply and reliably while securing safety at the time of inspection.

In the failure detection system 2 described above, since the failure of the bypass diode is detected when the potential difference measured for the photovoltaic string 130 is greater than the threshold V_{TH0}, it is possible to detect the failure of the bypass diode 150 using a simple process or circuit configuration. Further, since the value I₁ of the current supplied to the photovoltaic string 130 at the time of inspection is greater than an average short-circuit current value I_{SC} for night of the photovoltaic string 130, it possible to accurately detect failure of the bypass diode 150 regardless of a power generation state of the photovoltaic string 130.

Further, it is possible to prevent failure of the photovoltaic string 130 by applying a high voltage to the photovoltaic string 130 at the time of failure inspection since the supply of the current to the photovoltaic string 130 is stopped when the potential difference measured for the photovoltaic string 130 is equal to or greater than the threshold V_{TH1}. That is, when a constant current greater than a short-circuit current flows in the photovoltaic string 130, there is a risk of generation of a high voltage in a reverse direction of the voltage generated at the time of power generation in the photovoltaic string 130, but it is possible to prevent the generation of such a high voltage by stopping the supply of the current when the potential difference of the photovoltaic string 130 becomes too great.

Further, the present invention is not limited to the above-described embodiments. For example, the control/determination unit 53 may detect the failure of the bypass diode by supplying currents having two or more current values to the detection target string 130 and determining whether the I-V properties of the detection target string 130 are linear based on potential differences measured by the voltage measurement unit 52 for the respective current values.

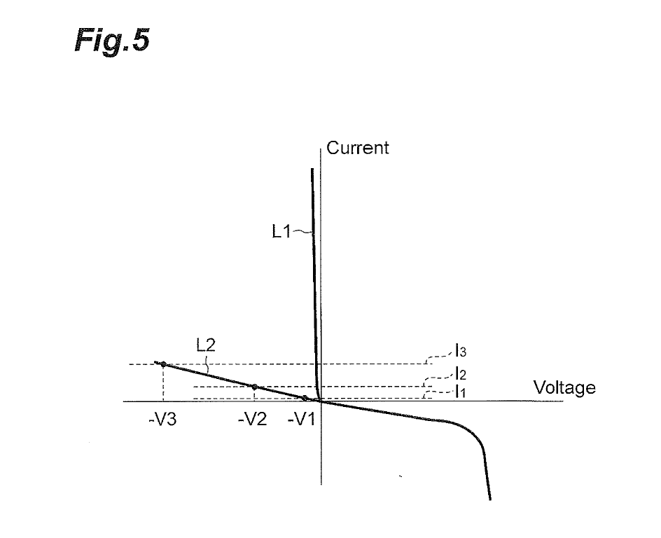

Specifically, in order to identify the I-V properties L1 and L2 of the detection target string 130 as illustrated in FIG. 5, the control/determination unit 53 performs control to continuously change a current value of the current supplied to the detection target string 130 into three values including I1, I2 and I3, and determines whether the bypass diode fails using the following determination criterion by referring to potential differences V1, V2 and V3 required according to the respective current values I1, I2 and I3. First, the control/determination unit 53 calculates a voltage value Vr using the following equation:

Vr=V1+{(V2−V1)/(I2−I1)}×(I3−I1)

based on the potential difference V1 and V2 measured for the current values I1 and I2. Also, when the measured potential difference V3 is smaller than the voltage value Vr by a specified value or more, the control/determination unit 53 regards the I-V properties of the detection target string 130 as non-linear and determines that the bypass diode is normal. On the other hand, if an absolute value |V3−Vr| of the difference between the measured potential difference V3 and the voltage value Vr is smaller than the specified value, the control/determination unit 53 regards the I-V properties of the detection target string 130 as linear and determines that the bypass diode is abnormal.

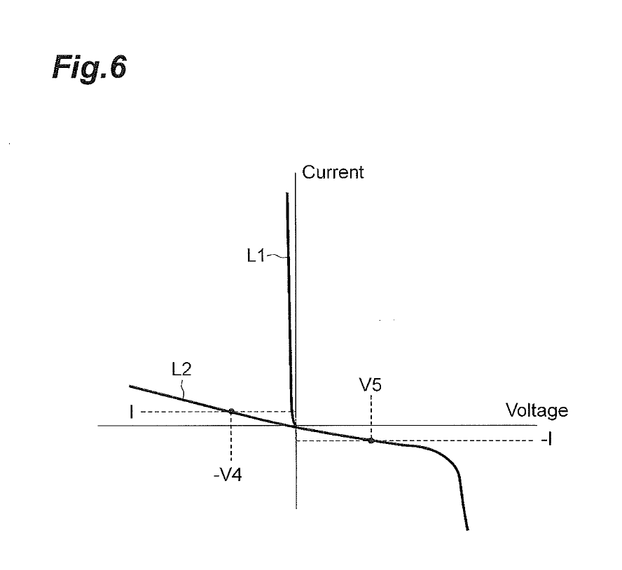

Further, the following failure determination method may be adopted as another determination method. That is, in order to identify the I-V properties L1 and L2 of the detection target string 130 as illustrated in FIG. 6, the control/determination unit 53 acquires a potential difference V4 measured when the current value I is supplied forward (in a direction from the negative electrode to the positive electrode) to the detection target string 130, and acquires a potential difference V5 measured when the current value I is supplied in reverse (in a direction from the positive electrode to the negative electrode) to the detection target string 130. Further, the control/determination unit 53 also acquires a voltage (open voltage) V0 (>0) generated in the detection target string 130 when the supplied current value is 0. Also, if a value of V4+V0 is smaller than a value of V5−V0 by a specified value or more with reference to the acquired potential differences V0, V4, and V5, the control/determination unit 53 determines that the bypass diode is normal. On the other hand, if a difference between the value of V5−V0 and the value of V4+V0 is smaller than a specified value, the control/determination unit 53 regards the I-V properties of the detection target string 130 as linear and determines that the bypass diode is abnormal.

Further, it is necessary to remove the backflow prevention diode from the electric path of the detection target string 130 when the voltage V5 in a reverse current is measured and detection of the failure of the bypass diode in the detection target string 130 is performed, as illustrated in FIG. 6. That is, in this case, it is necessary for individual backflow prevention diodes to be located on the power conditioner 110 side relative to the connection points 61 to 66 of the failure detection device 5 in the electric path connecting the individual photovoltaic strings 130 with the power conditioner 110.

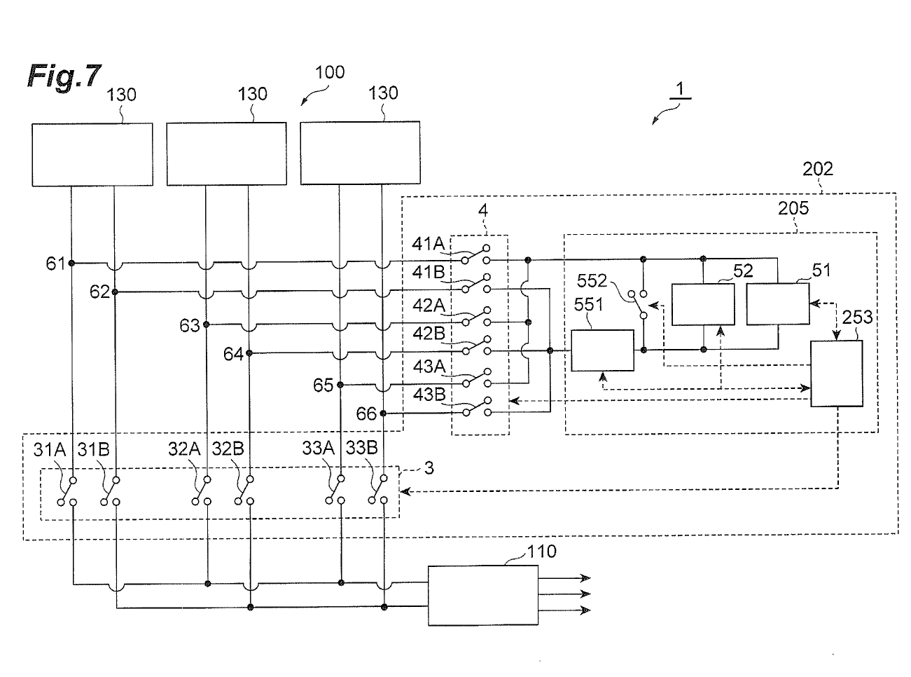

Further, the control/determination unit 53 may determine whether the detection target string 130 is actually generating power when determining a start timing of the failure inspection process for the bypass diode. FIG. 7 illustrates a configuration of a failure detection system 202 according to a modification example of the present invention in this case. A current measurement unit 551 for measuring a short-circuit current value when a detection target string 130 is short-circuited, and a switch 552 are further included in a failure detection device 205 of a failure detection system 202, as illustrated in FIG. 7. This current measurement unit 551 is configured to be connectable to a negative electrode and a positive electrode of the detection target string 130 via a switch array 4. Further, the switch 552 is a switch for short-circuiting the detection target string 130 including the current measurement unit 551, and is in an opened state when the short-circuit current is not measured. Just after the first switching step, a control/determination unit 253 determines whether the detection target string is generating power by causing the switch 552 to be in a closed state, acquiring the short-circuit current value measured by the current measurement unit 551, and comparing the short-circuit current value with the specified value, and starts a failure inspection process for the bypass diode when the detection target string is not generating power. For example, when the measured short-circuit current value is smaller than the specified value, the control/determination unit 253 determines that the detection target string 130 is not generating power. Alternatively, the control/determination unit 253 may determine whether the detection target string 130 is generating power based on a ratio of the constant current value I₁ to the measured short-circuit current value. For example, if I₁/I_{SC}≧α (α: integer), it may be determined that the detection target string 130 does not generate power (at night).

Further, in another embodiment, a portable device including only the failure detection device 5 in FIG. 1 may be prepared, and connected to the photovoltaic string, a photovoltaic module, or a photovoltaic cell cluster to perform detection.

While the method of performing detection at night has been described in the above-described embodiment, the detection can also be performed in the daytime while using the same voltage detection threshold as that used when the detection is performed at night by flowing a current greater than the short-circuit current of the photovoltaic cell.

In the failure detection device described above, it is preferable for the determination unit to detect the failure of the bypass diode when the potential difference measured in a state in which the current having the first value greater than the short-circuit current value of the photovoltaic module is supplied as the specified current value to the photovoltaic module is greater than the first threshold. Thus, by comparing the measured potential difference with the threshold, it is possible to detect the failure of the bypass diode using a simple process or circuit configuration.

Furthermore, it is preferable for the determination unit to detect the failure of the bypass diode based on whether the change in the potential difference measured in a state in which current values that are the first and second values are supplied as the specified current values to the photovoltaic module is linear based on the change, and for at least one of the current values that are the first and second values to be greater than the short-circuit current value of the photovoltaic module. If such a configuration is adopted, it is possible to determine whether voltage drop is caused by the parasitic resistance of the photovoltaic module or caused by the bypass diode by determining whether the measured potential difference is linearly changed. Accordingly, it is possible to realize reliable failure detection in consideration of a property change due to aged deterioration of the bypass diode.

Furthermore, it is preferable for the determination unit to stop the supply of the current to the photovoltaic module when the potential difference measured in a state in which the current having the first value greater than the short-circuit current value of the photovoltaic module is supplied as the specified current value to the photovoltaic module is greater than the first threshold or when the potential difference is equal to or greater than the second threshold equal to or greater than the first threshold. If such a determination unit is included, it is possible to prevent the failure of the photovoltaic module due to application of a high voltage to the photovoltaic module at the time of inspection of the failure. That is, when the constant current greater than the short-circuit current flows in the photovoltaic module, there is a risk of generation of a high voltage in a reverse direction of the voltage generated at the time of power generation in the photovoltaic module, but it is possible to prevent the generation of such a high voltage by stopping the supply of the current when the potential difference of the photovoltaic module becomes equal to or greater than the first or second threshold.

Further, it is preferable for the determination unit to determine whether the photovoltaic module is generating power based on a result of a comparison of the short-circuit current value measured when the photovoltaic module is short-circuited or the open voltage measured when the photovoltaic module is opened with the specified value, and to start a determination of the failure of the bypass diode when it is determined that the photovoltaic module is not generating power. If such a configuration is adopted, it is possible to determine a power generation state of the photovoltaic module using a simple determination method or a simple determination circuit.

In the failure detection system described above, it is preferable for the determination unit to detect the failure of the bypass diode when the potential difference measured in a state in which the current having the first value greater than the short-circuit current value of the photovoltaic module is supplied as the specified current value to the detection target string is greater than the first threshold. Thus, it is possible to detect the failure of the bypass diode using a simple process or circuit configuration by comparing the measured potential difference with the threshold.

Further, it is preferable for the determination unit to detect the failure of the bypass diode based on whether the change in the potential difference measured in a state in which the current values that are the first and second values are supplied as the specified current values to the detection target string is linear based on the change, and for at least one of the current values that are the first and second values to be greater than the short-circuit current value of the photovoltaic module. If such a configuration is adopted, it is possible to determine whether the voltage drop is caused by the parasitic resistance of the photovoltaic string or by the bypass diode by determining whether the measured potential difference is linearly changed. Accordingly, it is possible to realize reliable failure detection in consideration of a property change due to aged deterioration of the bypass diode.

Furthermore, it is preferable for the determination unit to stop the supply of the current to the detection target string when the potential difference measured in a state in which the current having the first value greater than the short-circuit current value of the photovoltaic module is supplied as the specified current value to the detection target string is greater than the first threshold or when the potential difference becomes equal to or greater than the second threshold equal to or greater than the first threshold. If such a determination unit is included, it is possible to prevent the failure of the photovoltaic string due to application of a high voltage to the photovoltaic string at the time of inspection of failure. That is, when a constant current greater than the short-circuit current flows in the photovoltaic string, there is a risk of generation of a high voltage in a reverse direction of the voltage generated at the time of power generation in the photovoltaic string, but it is possible to prevent the generation of such a high voltage by stopping the supply of the current when the potential difference of the photovoltaic string becomes equal to or greater than the first or second threshold.

Further, it is preferable for the determination unit to determine whether the detection target string is generating power based on the result of a comparison of the short-circuit current value measured when the photovoltaic module is short-circuited or the open voltage measured when the photovoltaic module is opened with the specified value, and to start a determination of the failure of the bypass diode when it is determined that the detection target string is not generating power. If such a configuration is adopted, it is possible to determine a power generation state of the photovoltaic string using a simple determination method or a simple determination circuit.

### INDUSTRIAL APPLICABILITY

In the present invention, the failure detection device, the failure detection system and the failure detection method for the bypass diode included in the photovoltaic module are use applications, and it is possible to detect the failure of the bypass diode built in the photovoltaic module reliably and easily while securing safety.

### REFERENCE SIGNS LIST

1: Solar power generation system (photovoltaic cell system), 2, 202: Failure detection system, 3: Switch array (switching unit), 5, 205: Failure detection device, 51: Current source circuit, 52: Voltage measurement unit, 53, 253: Control/determination unit, 61 to 66: Connection point, 100: Photovoltaic array, 110: Power conditioner (load device), 120: Photovoltaic module, 140: Photovoltaic cell, 150: Bypass diode, 551: Current measurement unit, 552: Switch.

1. A failure detection device configured to detect failure of a bypass diode for at least one photovoltaic module including photovoltaic cells that perform power generation using solar light and at least one bypass diode connected in parallel with the photovoltaic cell and disconnected from a load, the failure detection device comprising:
a current source configured to supply a current having a specified current value from a negative electrode to a positive electrode of the photovoltaic module;
a voltage measurement unit configured to measure a potential difference between the negative electrode and the positive electrode of the photovoltaic module when the current source supplies the current; and
a determination unit configured to determine failure of the bypass diode based on the potential difference measured by the voltage measurement unit.

2. The failure detection device according to claim 1, wherein, when the potential difference measured in a state in which a current having a first value greater than a short-circuit current value of the photovoltaic module is supplied as the specified current value to the photovoltaic module is greater than a first threshold, the determination unit detects the failure of the bypass diode.

3. The failure detection device according to claim 1, wherein the determination unit detects failure of the bypass diode based on whether a change in the potential difference measured in a state in which current values having first and second values are supplied as the specified current values to the photovoltaic module is linear based on the change, and
at least one of the current values that are the first and second values is a value greater than a short-circuit current value of the photovoltaic module.

4. The failure detection device according to claim 1, wherein, when the potential difference measured in a state in which a current having a first value greater than a short-circuit current value of the photovoltaic module is supplied as the specified current value to the photovoltaic module is greater than a first threshold or when the potential difference becomes equal to or greater than a second threshold equal to or greater than the first threshold, the determination unit stops the supply of the current to the photovoltaic module.

5. The failure detection device according to claim 1, wherein the determination unit determines whether the photovoltaic module is generating power based on a result of a comparison of a short-circuit current value measured when the photovoltaic module is short-circuited or an open voltage measured when the photovoltaic module is open with a specified value, and starts a determination of failure of the bypass diode when it is determined that the photovoltaic module is not generating power.

6. A failure detection system configured to detect failure of a bypass diode for a photovoltaic cell system including a photovoltaic string configured by serially connecting a plurality of photovoltaic modules, each including a plurality of photovoltaic cells connected in series and performing power generation using solar light and at least one bypass diode connected in parallel with the plurality of photovoltaic cells, and a load device connected to the photovoltaic string, the system comprising:
a switching unit configured to switch a connection between the photovoltaic string and the load device to a disconnection state;
a current source configured to set the photovoltaic string switched to a disconnection state by the switching unit as a detection target string and supply a current having a specified current value from a negative electrode to a positive electrode of the detection target string;
a voltage measurement unit configured to measure a potential difference between the negative electrode and the positive electrode of the detection target string when the current source supplies the current; and
a determination unit configured to determine failure of the bypass diode based on the potential difference measured by the voltage measurement unit.

7. The failure detection system according to claim 6, wherein, when the potential difference measured in a state in which a current having a first value greater than a short-circuit current value of the photovoltaic module is supplied as the specified current value to the detection target string is greater than a first threshold, the determination unit detects the failure of the bypass diode.

8. The failure detection system according to claim 6, wherein the determination unit detects failure of the bypass diode based on whether a change in the potential difference measured in a state in which current values having first and second values are supplied as the specified current values to the detection target string is linear based on the change, and
at least one of the current values that are the first and second values is a value greater than a short-circuit current value of the photovoltaic module.

9. The failure detection system according to claim 6, wherein, when the potential difference measured in a state in which the current having a first value greater than a short-circuit current value of the photovoltaic module is supplied as the specified current value to the detection target string is greater than a first threshold or when the potential difference becomes equal to or greater than a second threshold equal to or greater than the first threshold, the determination unit stops the supply of the current to the detection target string.

10. The failure detection system according to claim 6, wherein the determination unit determines whether the detection target string is generating power based on a result of a comparison of a short-circuit current value measured when the photovoltaic module is short-circuited or an open voltage measured when the photovoltaic module is open with a specified value, and starts a determination of failure of the bypass diode when it is determined that the detection target string is not generating power.

11. A failure detection method for detecting failure of a bypass diode for at least one photovoltaic module including photovoltaic cells that perform power generation using solar light and at least one bypass diode connected in parallel with the photovoltaic cell and disconnected from a load, the failure detection method comprising:
supplying a current having a specified current value from a negative electrode to a positive electrode of the photovoltaic module;
measuring a potential difference between the negative electrode and the positive electrode of the photovoltaic module when the current is supplied; and
determining a failure of the bypass diode based on the measured potential difference.

12. A failure detection method for detecting failure of a bypass diode for a photovoltaic cell system including a photovoltaic string configured by serially connecting a plurality of photovoltaic modules, each including a plurality of photovoltaic cells connected in series and performing power generation using solar light and at least one bypass diode connected in parallel with the plurality of photovoltaic cells, and a load device connected to the photovoltaic string, the method comprising:
switching a connection between the photovoltaic string and the load device to a disconnection state;
setting the photovoltaic string switched to the disconnection state as a detection target string, and supplying a current having a specified current value from a negative electrode to a positive electrode of the detection target string;
measuring a potential difference between the negative electrode and the positive electrode of the detection target string when the current is supplied; and
determining a failure of the bypass diode based on the measured potential difference.
